(19) United States
(12) Patent Application Publication
(10) Pub. No.: US 2019/0073737 A1
(43) Pub. Date: Mar. 7, 2019

(54) Facilitating Cross-Platform Transportation Arrangements with Third Party Providers

(71) Applicant: Allstate Insurance Company, Northbrook, IL (US)

(72) Inventor: Michael Joseph Marchio, Naperville, IL (US)

(21) Appl. No.: 15/696,635

(22) Filed: Sep. 6, 2017

(51) Int. Cl. G06Q 50/30; G06Q 20/10

(52) U.S. Cl. CPC G06Q 50/30; G06Q 30/0645; G06Q 20/10

(57) ABSTRACT

Aspects of the disclosure relate to facilitating cross-platform transportation arrangements with third party providers. In some instances, a first computing transportation may scrape information from one or more third party computing devices. The first computing device may populate a transportation arrangement resource shell with the scraped information from the one or more third party computing devices. In response to populating the transportation arrangement resource shell, the first computing device may retrieve stored data corresponding to visual elements of the first computing device. Using the retrieved data, the first computing device may generate a composite rendering that provides information associated with the one or more third party computing devices with visually perceptible elements of the retrieved data corresponding to the first computing device.

### FIELD

Aspects described herein are generally related to facilitating cross-platform transportation arrangements with third party providers. More specifically, aspects described herein relate to generating a composite rendering that includes visual elements of a host platform and content of one or more third party platforms.

### BACKGROUND

Facilitating cross-platform transportation arrangements between disparate entities after a vehicle accident can pose significant technological challenges. In existing systems, a host platform associated with a driver of a vehicle damaged in the accident may perform redirections to one or more third party platforms associated various transportation methods including rental car and ride share providers, as well as public transportation services. By performing such redirections, however, the host platform loses web traffic and/or application usage associated with the user, ability to control user experience, and command of data produced by the user in interactions with the third party platforms.

### BRIEF SUMMARY

Aspects of the disclosure address these and/or other technological shortcomings by to generating a composite rendering that includes visual elements of a host platform and content of a third-party platform. In particular, one or more aspects of the disclosure provide effective, efficient, scalable, and convenient technical solutions that address and overcome the technical problems associated with transportation arrangement systems.

In accordance with one or more embodiments, a transportation arrangement computing device may scrape information from one or more third party computing devices. The transportation arrangement computing device may populate a transportation arrangement resource shell with the information from the one or more third party computing devices. In response to populating the transportation arrangement resource shell, the transportation arrangement computing device may retrieve stored data corresponding to the transportation arrangement computing device. Using the retrieved data, the transportation arrangement computing device may generate a composite rendering that provides information associated with the one or more third party computing devices with visually perceptible elements of the retrieved data corresponding to the transportation arrangement computing device.

In some embodiments, the transportation arrangement computing device may receive a signal indicating a transportation arrangement request through the composite rendering from a user computing device. The transportation arrangement computing device may facilitate the transportation arrangement request between a third party computing device from the one or more third party computing devices corresponding to the transportation arrangement request and the user computing device.

In some embodiments, the transportation arrangement computing device may identify a credit amount associated with a policy of a user of the transportation arrangement computing device. The transportation arrangement computing device may deduct an amount corresponding to a value of the transportation arrangement request from the credit amount associated with the policy of the user.

In some embodiments, the transportation arrangement computing device may fetch content from one or more third party computing devices. The transportation arrangement computing device may extract page content from the fetched content, wherein the page content may include at least a type of transportation and one or more input fields for arranging the type of transportation.

In some embodiments, the composite rendering may provide the information from the one or more third party computing devices in a construct provided by the transportation arrangement resource shell with visual elements corresponding to the transportation arrangement computing device.

In some embodiments, the one or more third party computing devices are associated with one or more of ride share services, rental car services, and public transportation services.

In some embodiments, the transportation arrangement computing device may identify one or more of the ride share services, rental car services, and public transportation services corresponding to the one or more third party computing devices based on locational data received from a user computing device.

These features, along with many others, are discussed in greater detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIGS. 1A and 1B depict an illustrative computing environment for facilitating cross-platform transportation arrangements in accordance with one or more aspects of the disclosure;

FIGS. 2A, 2B, 2C, 2D, 2E, and 2F depict an illustrative event sequence for facilitating cross-platform transportation arrangements in accordance with one or more aspects of the disclosure;

FIG. 3 illustrates an example method for facilitating cross-platform transportation arrangements in accordance with one or more aspects of the disclosure; and

FIG. 4 illustrates a network environment and computing systems that may be used to implement one or more aspects of the disclosure.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. In addition, aspects may take the form of a computing device configured to perform specified actions. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

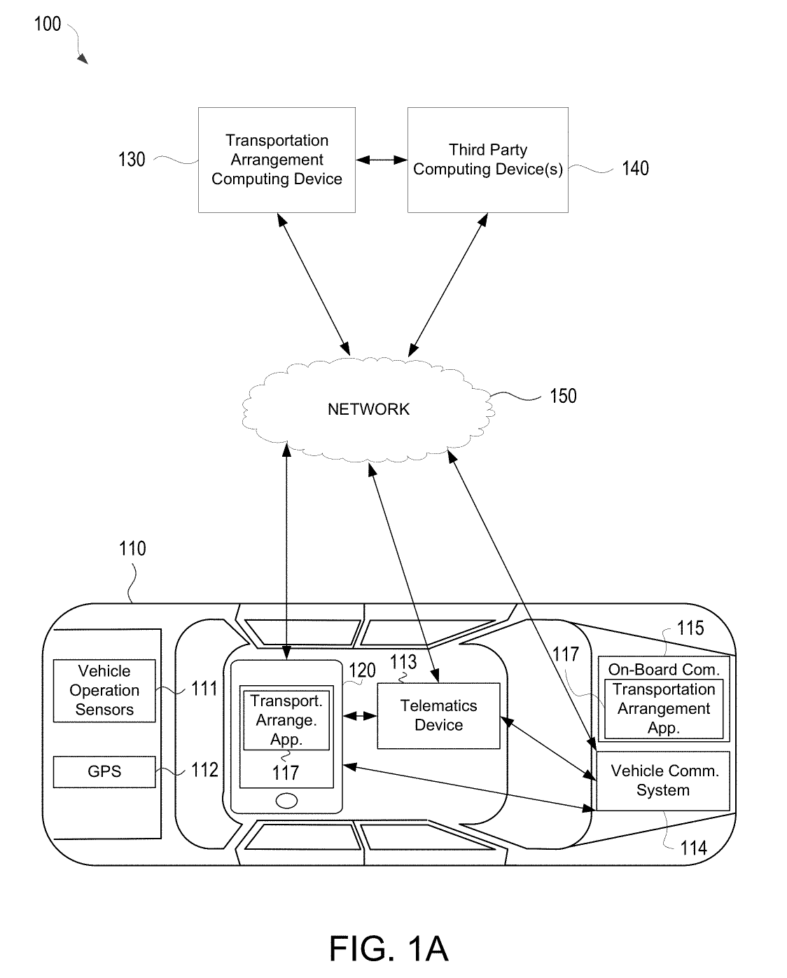

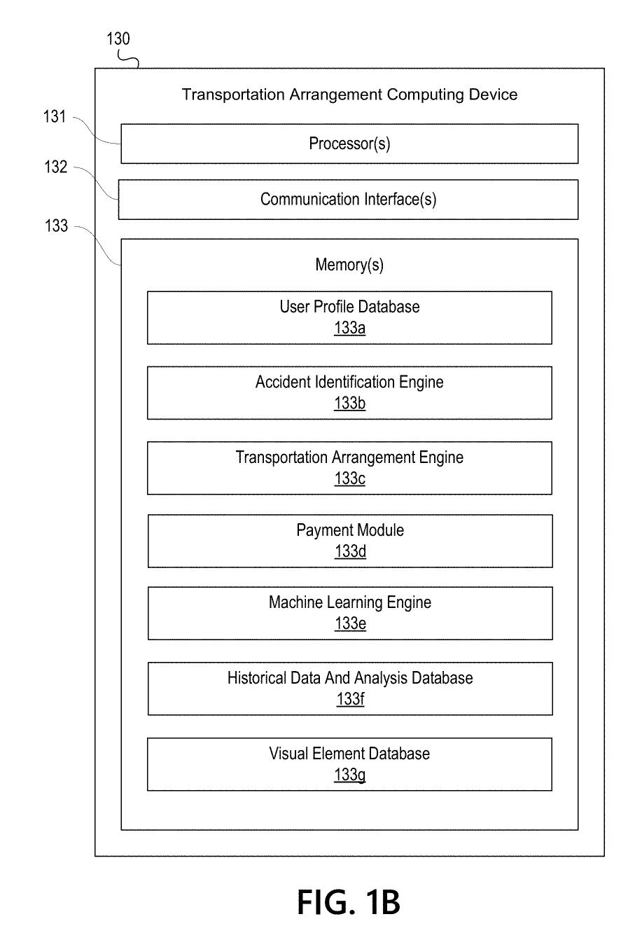

FIG. 1A depicts an illustrative computing environment for facilitating cross-platform transportation arrangements in accordance with one or more aspects of the disclosure. The transportation arrangement system 100 may include vehicle 110, transportation arrangement computing device 130, and one or more third party computing device(s) 140. The vehicle 110 may include one or more components associated therewith such as vehicle operation sensors 111, GPS 112, telematics device 113, vehicle communication system 114, on-board computer 115, and the like. Additionally, mobile computing device 120 may be included in vehicle 110. In some instances, the mobile device 120 may be associated with an owner, driver, or passenger of vehicle 110. Although FIG. 1A illustrates only one vehicle 110, the transportation arrangement system 100 may be configured to communicate with multiple vehicles 110 and associated components and also may include multiple third party computing devices without departing from the invention.

The vehicle 110 and one or more components associated therewith (e.g., vehicle operation sensors 111, GPS 112, telematics device 113, vehicle communication system 114, on-board computer 115, and the like), mobile device 120, transportation arrangement computing device 130, and one or more third party computing device(s) 140 may be configured to communicate with each other through network 150. Each component shown in FIG. 1A may be implemented in hardware, software, or a combination of the two.

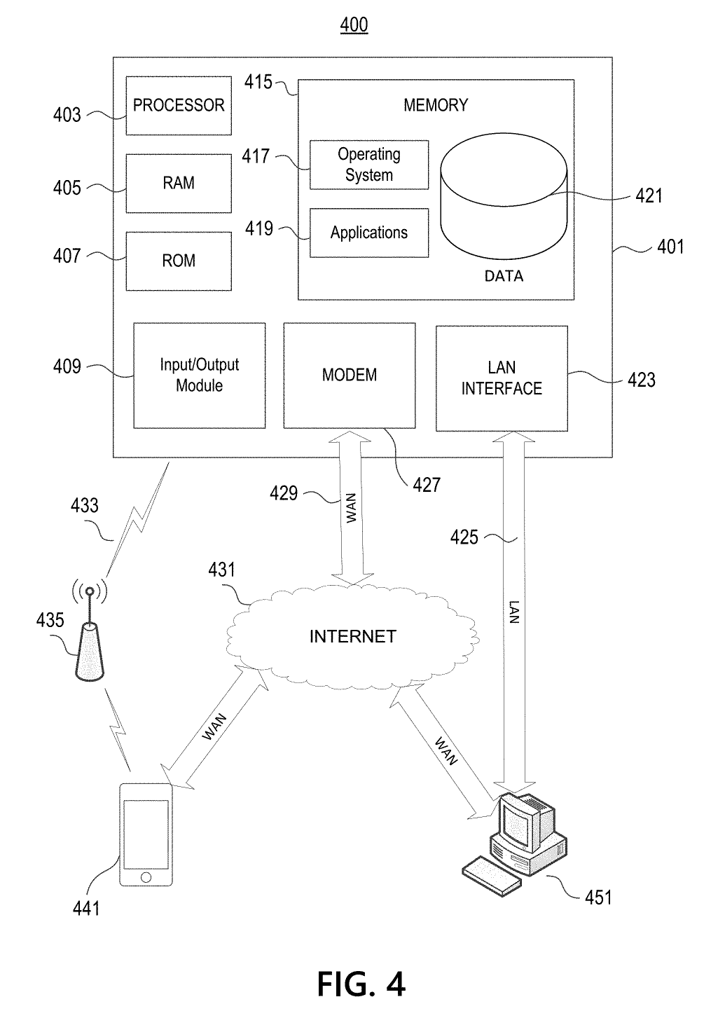

Additionally, each component of the transportation arrangement system 100 may include a computing device (or system) having some or all of the structural components described below in regard to computing device 401 of FIG. 4.

Vehicle 110 of the transportation arrangement system 100 may be an automobile, motorcycle, scooter, bus, van, truck, semi-truck, train, boat, recreational vehicle, or other vehicle. The vehicle 110 may further be an autonomous vehicle, semi-autonomous vehicle, or non-autonomous vehicle. In some examples, vehicle 110 may include vehicle operation/performance sensors 111 capable of detecting, recording, and transmitting various vehicle performance and/or operational data. For example, sensors 111 may detect, store, and transmit data corresponding to the vehicle's speed, rates of acceleration and/or deceleration, braking, swerving, and the like. Sensors 111 also may detect, store and/or transmit data received from the vehicle's internal systems, such as impact to the body of the vehicle, air bag deployment, headlight usage, brake light operation, door opening and closing, door locking and unlocking, cruise control usage, hazard light usage, windshield wiper usage, horn usage, turn signal usage, seat belt usage, phone and radio usage within the vehicle, internal decibel levels, and other data collected by the vehicle's computer systems. Further, sensors 111 may detect, store, and transmit data relating to the maintenance of the vehicle 110, such as the engine status, oil level, engine coolant temperature, odometer reading, level of fuel in the fuel tank, engine revolutions per minute (RPMs), and/or tire pressure.

Additionally, vehicle sensors 111 may be configured to independently transmit the above-mentioned data to one or more computing devices and/or systems including telematics device 113, on-board computer 115, mobile device 120, transportation arrangement computing device 130, and/or third party computing device(s) 140. In some instances, the data transmission to the mobile device 120, transportation arrangement computing device 130, and/or third party computing device(s) 140 may be performed via on-board computer 115. In such cases, the on-board computer 115 may be configured to transmit the data received from vehicle sensors 111 to mobile device 120, transportation arrangement computing device 130, and/or third party computing device(s) 140 by way of vehicle communication system 114.

Vehicle 110 may include a Global Positioning System (GPS) 112 which may be used to generate data corresponding to the position, heading, orientation, location, velocity, and/or acceleration of vehicle 110. GPS 112 may be configured to independently transmit the above-mentioned data to one or more computing systems including telematics device 113, on-board computer 115, mobile device 120, transportation arrangement computing device 130, and/or third party computing device(s) 140. In some instances, the data transmission to the mobile device 120, transportation arrangement computing device 130, and/or third party computing device(s) 140 may be performed via on-board computer 115. In such cases, the on-board computer 115 may be configured to transmit the data received from GPS 112 to mobile device 120, transportation arrangement computing device 130, and/or third party computing device(s) 140 by way of vehicle communication system 114.

Telematics device 113 may be configured to receive the vehicle performance and/or operational data and vehicle locational information in the form of a data stream from on-board computer 115 via a data port, Bluetooth interface, or any comparable communication interface of the vehicle 110. For example, telematics device 113 may include an on-board diagnostic (OBD) device adapter and may be connected to an OBD port of the vehicle 110 through which on-board computer 115 may be configured to transmit data to telematics device 113. In certain embodiments, telematics device 113 may be configured to receive vehicle performance and/or operational data and vehicle locational information directly from vehicle sensors 111, GPS 112, on-board computer 115, and/or mobile device 120 via a wired or wireless connection. Telematics device 113 may include a memory to store data received from vehicle sensors 111, GPS 112, on-board computer 115, and/or mobile device 120.

The vehicle performance and/or operational data and vehicle locational information may be collected with appropriate permissions (e.g., from the driver, vehicle owner, and the like) and may include operational data from an industry standard port such as a SAE-1962 connector, or an on board diagnostic (“OBD”) port or other vehicle data acquiring component. For example, operation data accessible via the OBDII port includes speed and engine throttle position or other variable power controls of the vehicle power source. It may also include so called “extended OBDII” or OBDIII datasets that are specific to each manufacturer and also available with manufacturer permission such as odometer readings, activation of brakes, degree and duration of steering direction, and implementation of accident avoidance devices such as turning signals, headlights, seatbelts, activation of automated braking systems (ABS), and the like. Other information regarding the operation of the vehicle may be collected such as, but not limited to, interior and exterior vehicle temperature, window displacement, exterior vehicle barometric pressure, exhaust pressure, vehicle emissions, turbo blower pressure, turbo charger RPM, vehicle GPS location, and the like. The system may recognize or be configured to recognize a particular language emitted by the vehicle system and may configure the recording component to receive or convert data in SAE J1850, ISO IS09141 or KWP 2000 formats. Accordingly, U.S. and/or international OBD standards may be accommodated. For instance, data may be collected from a variety of U.S. and/or international port types to permit use in a variety of locations. Alternatively, this step may be performed by a processor after the data is recorded.

Telematics device 113 may also include sensors such as, but not limited, an accelerometer, compass, gyroscope, and GPS. Additionally, telematics device 113 may include antennas to communicate with other devices wirelessly. For example, telematics device 113 may communicate with on-board computer 115, mobile device 120, transportation arrangement computing device 130, and/or third party computing device(s) 140 over a wide area network (WAN), cellular network, Wi-Fi network, and the like. Telematics device 113 may also communicate with on-board computer 115 and mobile device 120 via a Bluetooth connection. In certain embodiments, telematics device 113 may be configured to establish a secure communication link and/or channel with on-board computer 115, mobile device 120, transportation arrangement computing device 130, and/or third party computing device(s) 140.

In some arrangements, telematics device 113 may include a telematics application operating on on-board computer 115 and/or mobile computing device 120 and may utilize hardware components comprised within on-board computer 115 and/or mobile computing device 120 (e.g., memory, processors, communication hardware, sensors, and the like) to receive, store, and/or transmit vehicle performance and/or operational data and vehicle locational information.

Vehicle communication systems 114 may be vehicle-based data transmission systems configured to transmit vehicle information and/or operational data and vehicle locational information to external computing systems and/or other nearby vehicles and infrastructure, and to receive data from external computing systems and/or other nearby vehicles and infrastructure. In some examples, communication systems 114 may use the dedicated short-range communications (DSRC) protocols and standards to perform wireless communications between vehicles and/or external infrastructure such as bridges, guardrails, barricades, and the like.

Vehicle communication systems 114 may be implemented using wireless protocols such as WLAN communication protocols (e.g., IEEE 802.11), Bluetooth (e.g., IEEE 802.15.1), one or more of the Communication Access for Land Mobiles (CALM) wireless communication protocols and air interfaces, and the like. In certain systems, communication systems 114 may include specialized hardware installed in vehicle 110 (e.g., transceivers, antennas, and the like) to facilitate near field communication (NFC) and/or radio-frequency identification (RFID), while in other examples the communication systems 114 may be implemented using existing vehicle hardware components (e.g., radio and satellite equipment, navigation computers). In some instances, the vehicle communication systems 114 may be configured to transmit and receive data from vehicle sensors 111, GPS 112, telematics device 113, on-board computer 115, mobile device 120, transportation arrangement computing device 130 and/or third party computing device(s) 140 over a wide area network (WAN), cellular network, Wi-Fi network, Bluetooth, RFID, and/or NFC.

On-board computer 115 may contain some or all of the hardware/software components as the computing device 401 of FIG. 4. Vehicle control computer 115 may be configured to operate one or more internal vehicle systems and/or components including at least a vehicle sound system, dashboard display and/or heads-up display system, output speakers, interior lighting system, climate control system, ignition system, door locking system, and the like. Similarly, on-board computer 115 may be configured to operate one or more external vehicle systems and/or components including windshield wipers, exterior lighting systems (e.g., headlights, tail lights, running lights, turn signals, emergency lights, etc.), emission and exhaust systems, fuel systems, suspension systems, transmission systems, and the like. In some instances, vehicle control computer 115 may be configured to perform the transportation arrangement methods as described in further detail below in conjunction with mobile computing device 120, transportation arrangement computing device 130, and/or third party computing device(s) 140.

Additionally, on-board computer 115 may include a display screen for presenting information to a driver of vehicle 110 pertaining to any of a plurality of applications such as a telematics application, transportation arrangement application 117, and the like. In some instances, the display screen may be a touch screen and may be configured to receive user touch input. Alternatively, the display screen may not be a touch screen and, instead, the on-board computer 115 may receive user input and provide output through one or more of the input/output modules 409 described in detail in regard to FIG. 4.

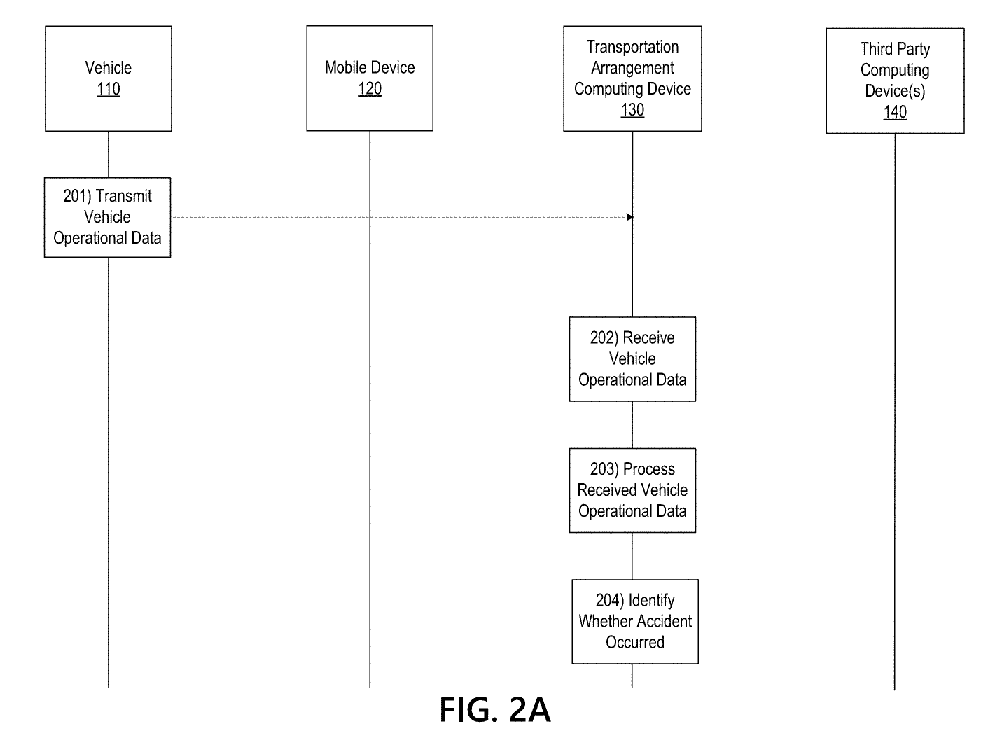

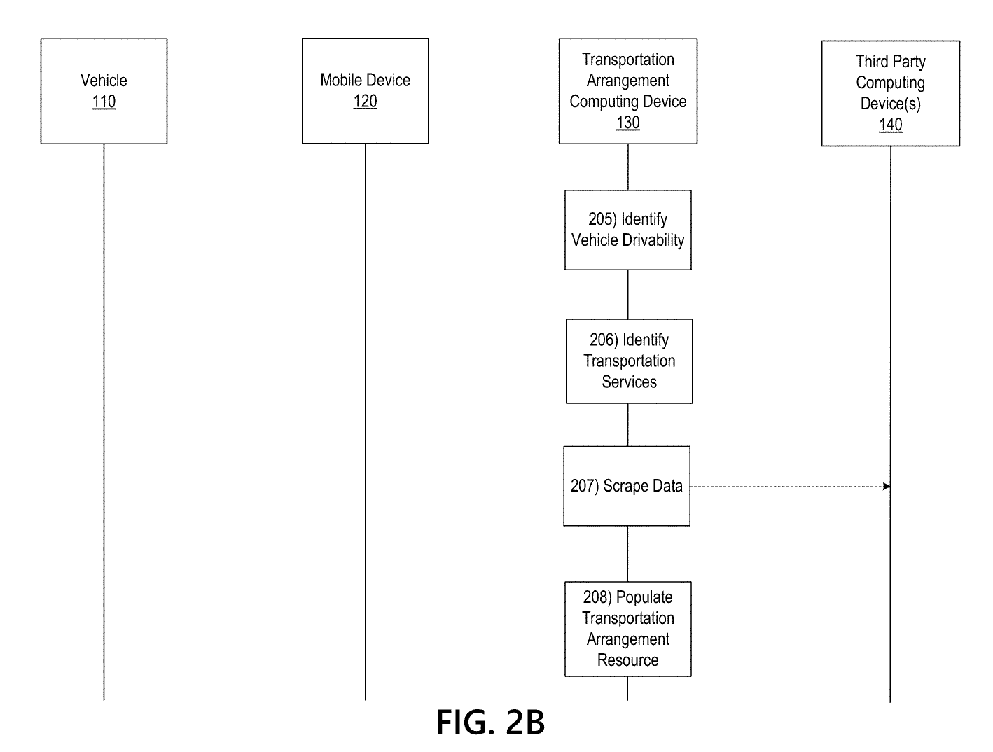

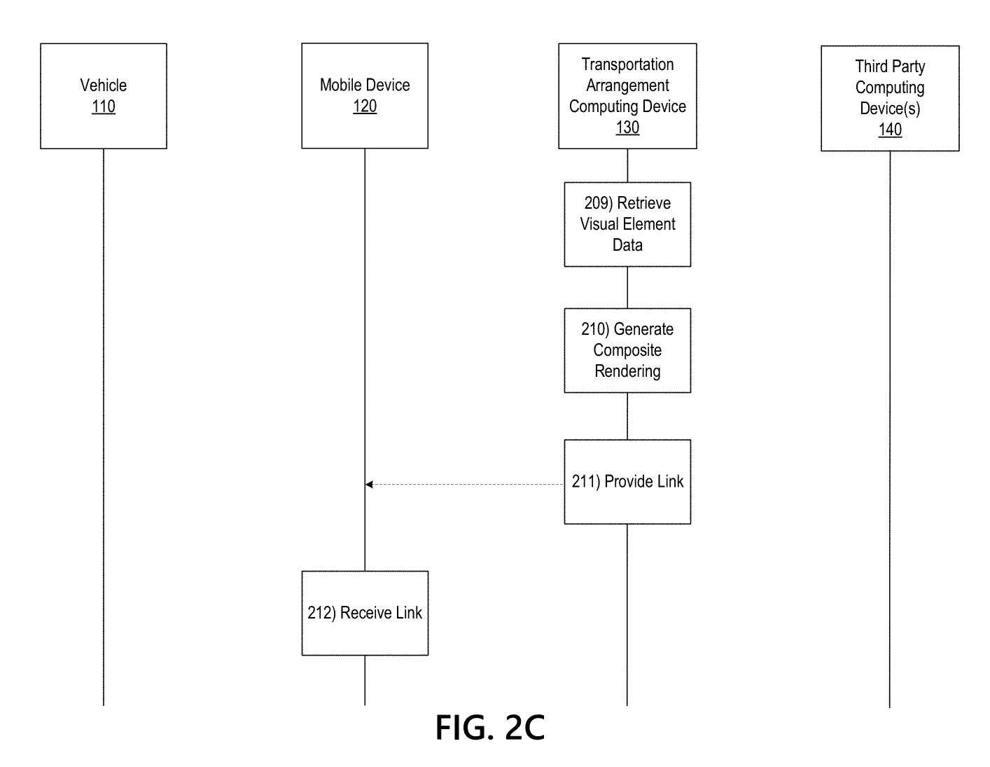

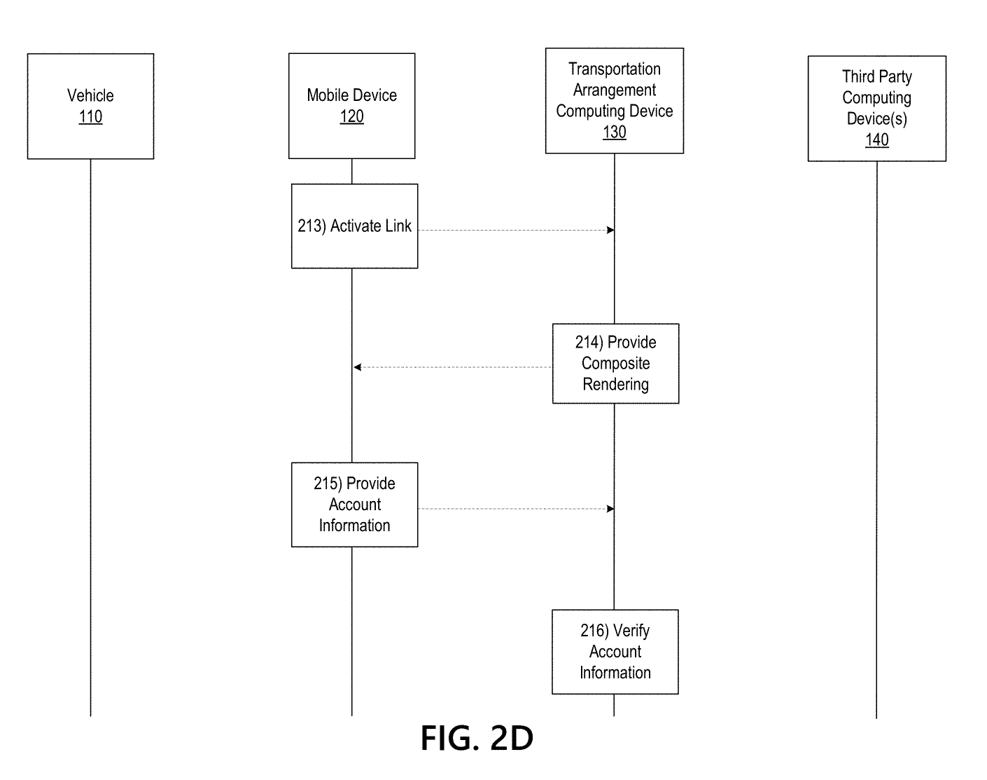

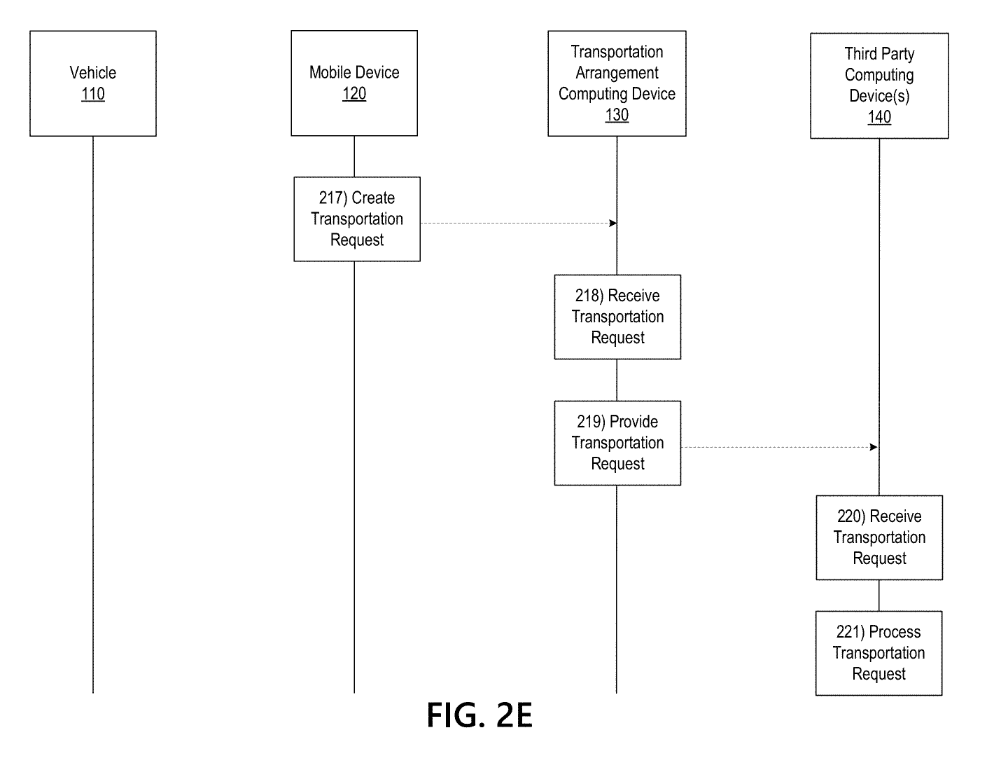

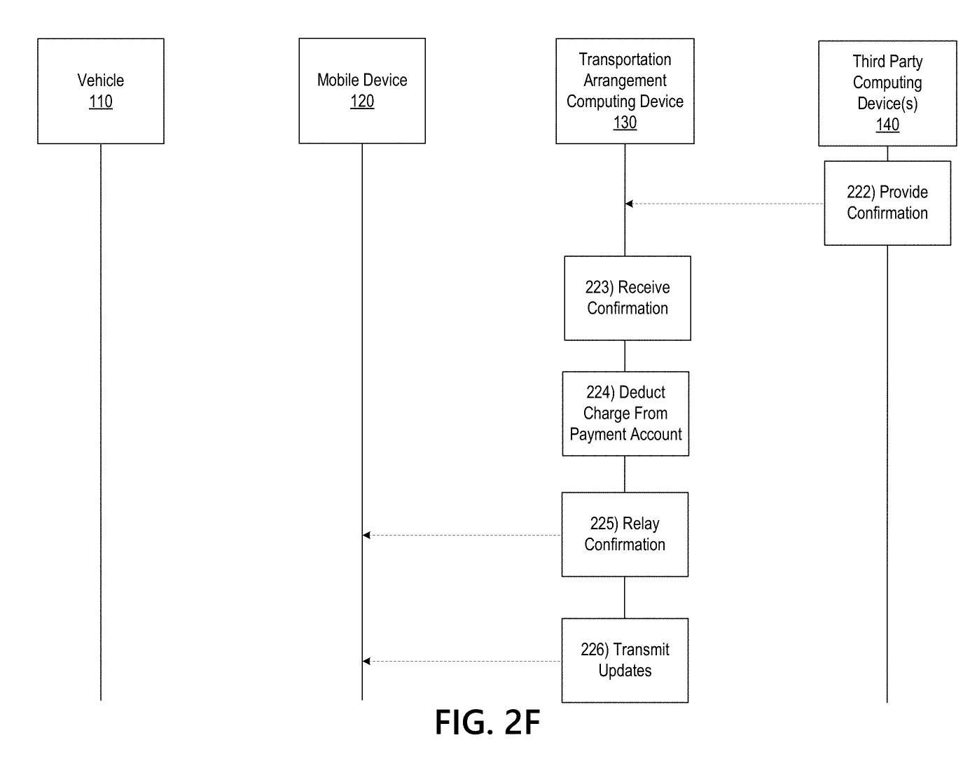

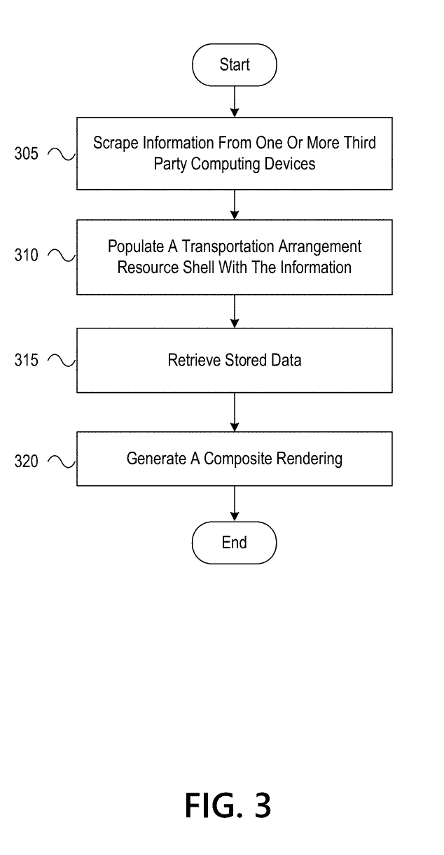

In some instances, on-board computer 115 may be configured to perform one or more of the methods and/or processes corresponding to facilitating cross-platform transportation arrangements as described in further detail below independently and/or in conjunction with one or more sensors and/or computing devices such as sensors 111, GPS 112, telematics device 113, mobile device 120, transportation arrangement computing device 130, and/or third party computing device(s) 140. In particular, and in regard to the illustrative event sequence for facilitating cross-platform transportation arrangements described in FIGS. 2A-2F and the example method for facilitating cross-platform transportation arrangements described in FIG. 3, on-board computer 115 may be configured to perform the processes in combination with, and/or independently of, vehicle 110 and corresponding components (e.g., sensors 111, GPS 112, and telematics device 113), mobile device 120, and transportation arrangement computing device 130, as well as third party computing device(s) 140 in instances in which they are used. In performing such methods, on-board computer 115 may be configured to receive, detect, store, and transmit vehicle performance and/or operational data, vehicle locational information, transportation arrangement data, and/or third party data. Furthermore, on-board computer 115 may be configured to receive, store, and transmit vehicle performance and/or operational data, vehicle locational information, transportation arrangement data, third party data, and/or data produced during the performance of the methods corresponding to facilitating cross-platform transportation arrangements from sensors 111, GPS 112, telematics device 113, mobile device 120, transportation arrangement computing device 130, and/or one or more third party computing device(s) 140.

Mobile computing device 120 may be, for example, a mobile phone, personal digital assistant (PDA), or tablet computer associated with the driver or passenger(s) of vehicle 110. As such, mobile computing device 120 may be included within the vehicle 110 and, in some instances, may be used to independently collect vehicle performance and/or operational data, and/or vehicle locational information, as well as to receive vehicle performance and/or operational data, vehicle locational information, transportation arrangement data, third party data, and the like from one or more computing systems (e.g., vehicle operation sensors 111, GPS 112, telematics device 113, on-board computer 115, transportation arrangement computing device 130, and/or third party computing device(s) 140). Mobile computing device 120 may be configured to transmit the independently collected vehicle performance and/or operational data, vehicle locational information, and/or the received vehicle performance and/or operational data, vehicle locational information, transportation arrangement data, third party data, and the like to one or more computing devices (e.g., telematics device 113, on-board computer 115, transportation arrangement computing device 130, and/or third party computing device(s) 140).

In one example, mobile computing device 120 may be configured to execute a program and/or application (e.g., telematics application, transportation arrangement application 117, and the like) that provides computer-executable instructions for independently detecting vehicle performance and/or operational data, vehicle locational information, and mobile device usage data and/or receiving vehicle performance and/or operational data, vehicle locational information, transportation arrangement data, third party data, and the like from one or more internal and/or external computing systems. With respect to independent vehicle performance and/or operational data and vehicle information detection and collection, mobile device 120 may be equipped with one or more accelerometers and/or GPS systems which may be accessed by the mobile computing device 120 after executing computer-executable instructions of the software program and/or application (e.g., telematics application, transportation arrangement application 117, and the like) to determine vehicle location (e.g., longitude, latitude, and altitude), heading (e.g., orientation), velocity, acceleration, direction, cornering (e.g., acceleration during turning), and other driving data.

Mobile computing device 120 may be configured to perform one or more of the methods and/or processes in facilitating cross-platform transportation arrangement as described in further detail below independently and/or in conjunction with one or more sensors and/or computing devices such as sensors 111, GPS 112, telematics device 113, on-board computer 115, transportation arrangement computing device 130, and/or third party computing device(s) 140. In particular, and in regard to the illustrative event sequence for the facilitating cross-platform transportation arrangement described in FIGS. 2A-2F and the example method for the facilitating cross-platform transportation arrangement described in FIG. 3, mobile device 120 may be configured to perform the processes in combination with, and/or independently of, vehicle 110 and corresponding components (e.g., sensors 111, GPS 112, telematics device 113, and on-board computer 115) and transportation arrangement computing device 130, as well as third party computing device(s) 140 in instances in which they are used. In performing such methods, mobile device 120 may be configured to detect, store, and transmit vehicle performance and/or operational data, vehicle locational information, and/or mobile device usage data. Furthermore, mobile device 120 may be configured to receive, store, and transmit vehicle performance and/or operational data, vehicle locational information, transportation arrangement data, third party data, and/or data produced during the performance of the methods and/or processes in facilitating cross-platform transportation arrangement from sensors 111, GPS 112, telematics device 113, on-board computer 115, transportation arrangement computing device 130, and/or one or more third party computing device(s) 140.

The transportation arrangement system 100 may include a transportation arrangement computing device 130. The transportation arrangement computing device 130 may be a computing device containing some or all of the hardware/software components as the computing device 401 of FIG. 4. In some instances, the analysis of the vehicle performance and/or operational data, vehicle locational information, transportation arrangement data, third party data, and the like, as described in further detail below, may be performed by transportation arrangement computing device 130. In such instances, any one, or combination of, sensors 111, GPS 112, telematics device 113, on-board computer 115, mobile device 120, and one or more third party computing device(s) 140 may transmit data to transportation arrangement computing device 130. Such data may include any of the above-mentioned vehicle performance and/or operational data, vehicle locational information, transportation arrangement data, third party data, and the like. Upon receipt of the data, transportation arrangement computing device 130, alone or in combination, with mobile device 120 and/or on-board computer 115 may be able to perform the processes outlined below.

The one or more third party computing device(s) 140 may contain some or all of the hardware/software components as the computing device 401 of FIG. 4. Each of the one or more third party computing device(s) 140 may be respectively associated with a particular transportation entity (e.g., ride share services, rental car companies, public transportation providers, and the like). As such, each of the one or more third party computing device(s) 140 may store data corresponding to the particular entity to which it is associated. Thus, the one or more third party computing device(s) 140 may be configured to communicate with any one of on-board computer 115, mobile device 120, and/or transportation arrangement computing device 130 in order to provide information corresponding to the particular entity that each of the one or more third party computing device(s) 140 corresponds. Additionally and/or alternatively, the one or more third party computing device(s) 140 may be configured to receive and transmit data to vehicle sensors 111, GPS 112, telematics device 113, on-board computer 115, mobile device 120, and/or transportation arrangement computing device 130.

As stated above, computing environment 100 also may include one or more networks, which may interconnect one or more of vehicle 110 and the components associated therewith (e.g., vehicle operation sensors 111, GPS 112, telematics device 113, vehicle communication system 114, on-board computer 115, and the like), mobile device 120, transportation arrangement computing device 130, and one or more third party computing device(s) 140. For example, computing environment 100 may include network 150. Network 150 may include one or more sub-networks (e.g., local area networks (LANs), wide area networks (WANs), or the like).

Referring to FIG. 1B, transportation arrangement computing device 130 may include processor(s) 131, communication interface(s) 132, and memory 133. A data bus may communicatively couple processor(s) 131, communication interface(s) 132, and memory 133. Communication interface(s) 132 may be a network interface configured to support communication between transportation arrangement computing device 130 and one or more networks (e.g., network 150).

Memory 133 may include one or more program modules, engines, and/or databases having instructions that when executed by processor(s) 131 cause transportation arrangement computing device 130 to perform one or more functions described herein. In some instances, the one or more program modules, engines, and/or databases may be stored by and/or maintained in different memory units of transportation arrangement computing device 130. For example, memory 133 may have, store, and/or include a user profile database 133a, accident identification engine 133b, transportation arrangement engine 133c, payment module 133d, machine learning engine 133e, historical data and analysis database 133f, and visual element database 133g.

User profile database 133a may store information corresponding to a user of transportation arrangement application 117 installed on mobile device 120 and/or on-board computing device 115. In some instances, the user of the transportation arrangement application 117 may be the owner of vehicle 110. Accordingly, the information stored in user profile database 133a may relate to insurance account information (e.g., policy information) associated with the owner, vehicle information associated with the owner such as year, make, and model, financial information associated with the owner, contact information such as phone number, email, and address, and information as pertaining to the owner's usage of the accident identification engine 133b, transportation arrangement engine 133c, payment module 133d, machine learning engine 133e, and historical data and analysis database 133f. Additionally, user profile database 133a may store information corresponding to a user of a telematics device 120 and/or telematics application stored on one or more of mobile device 120 and on-board computing device 115. As noted above, such information may include vehicle performance and/or operational data, vehicle locational information, and the like. In some instances, user profile database 133a may further store account and/or rewards information related to the user in regard one or more transportation service providers.

Accident identification engine 133b may have or include instructions that direct and/or cause transportation arrangement computing device 130 to receive vehicle operational data from one or more of vehicle 110 and one or more components associated therewith (e.g., vehicle operation sensors 111, GPS 112, telematics device 113, vehicle communication system 114, on-board computer 115, and the like) and mobile device 120. The accident identification engine 133b may have further instructions that direct and/or cause transportation arrangement computing device 130 to identify, based on the received vehicle operational data, whether vehicle 110 has been involved in an accident. Additionally, accident identification engine 133b may perform other functions, such as identifying whether or not vehicle 110 is drivable after an accident. In performing such processes, accident identification engine 133b may analyze the received the vehicle operational data through machine learning engine 133e, which may identify, based on previously received vehicle operational data corresponding to previous accidents, whether vehicle 110 is drivable after an accident.

Transportation arrangement engine 133c may store instructions that direct and/or cause transportation arrangement computing device 130 to receive vehicle locational information from vehicle 110 and, in particular, one or more components associated therewith (e.g., vehicle operation sensors 111, GPS 112, telematics device 113, vehicle communication system 114, on-board computer 115, and the like), as well as mobile device 120. The transportation arrangement engine 133c may have or include further instructions that direct and/or cause transportation arrangement computing device 130 to identify, based on the vehicle locational information, information corresponding to available transportation service providers in the immediate area corresponding to the vehicle location. Further, transportation arrangement engine 133c may be configured to cause transportation arrangement device 130 to facilitate cross-platform transportation arrangements with third party providers corresponding to third party computing device(s) 140. In some instances, the facilitation of cross-platform transportation arrangements may involve one or more of the available transportation service providers identified based on the locational information of the vehicle 110. In other instances, additional transportation service providers may be available.

In facilitating the cross-platform transportation arrangements, transportation arrangement engine 133c may be configured to cause transportation arrangement computing device 130 to generate a composite graphical rendering, such as a webpage and/or application interface, that includes visual and account elements of the transportation arrangement computing device 130 (e.g., host platform) and content of one or more third party platforms (e.g., third party computing device(s) 140). In doing so, transportation arrangement engine 133c may be configured to scrape one or more webpages and/or or applications associated with the third party computing device(s) 140. The scraping may include fetching the content of one or more webpages associated with the third party computing device(s) 140 and extracting page content such as type of transportation (e.g., ride share, public transportation, rental vehicle, and the like), input fields to arrange transportation (e.g., location, destination, payment information, transportation option, and the like) through parsing, searching, and reformatting. In regard to the input fields corresponding to the transportation option, such information may be dependent on the type of transportation. For example, in the event that the transportation type is public transportation, the input fields corresponding to the transportation option may include train and/or bus, train and/or bus number, train and/or bus direction, and the like. Similarly, in the event that the transportation type is a rental vehicle, the input fields corresponding to the transportation option may include vehicle make, model, year, and the like, and in the event that the transportation type is a ride share, the input fields corresponding to the transportation option may include passenger number (e.g., two passengers, three passengers, four passengers, and so on), vehicle size and/or quality (e.g., compact vehicle, luxury compact vehicle, luxury SUV, and the like), and the like.

Additionally, transportation arrangement engine 133c may be configured to cause transportation arrangement computing device 130 to form a composite graphical rendering, which includes the scraped information from each of the one or more webpages associated with the third party computing device(s) 140 with visual and account elements of the transportation arrangement computing device 130 (e.g., host platform). In doing so, transportation arrangement computing device 130 may be able to provide a solution to technological deficiencies of existing systems by maintaining traffic associated with the user, controlling user experience, and commanding data produced by the user in interactions with the third party platforms. For example, transportation arrangement computing device 130 may be able to control the user experience by generating the composite graphical rendering with the scraped information from each of the one or more webpages associated with the third party computing device(s) 140 with visual and account elements of the transportation arrangement computing device 130 (e.g., host platform). Further, the transportation arrangement computing device 130 may be able to maintain traffic and data command by enabling user interactions with the one or more webpages associated with the third party computing device(s) 140 through the composite graphical rendering, as will be described in detail below.

Payment module 133d may have or include instructions that allow transportation arrangement computing device 130 to provide payment from an account of an owner of vehicle 110 to one or more of the third party computing device(s) 140 in facilitating transportation arrangements. In some instances, the account of the owner of vehicle 110 may be credited with an amount of funds if the accident involving vehicle 110 causes vehicle 110 to be undrivable for a period of time. Additionally and/or alternatively, the account of the owner of vehicle 110 may be linked to one or more payment accounts associated with the owner of vehicle 110.

Machine learning engine 133e may have or include instructions that direct and/or cause transportation arrangement computing device 130 to set, define, and/or iteratively redefine parameters, rules, and/or other settings stored in historical data and analysis database 133f and used by accident identification engine 133b in determining one or more aspects or characteristics of an accident, such as identifying whether or not an accident involving vehicle 110 resulted in vehicle 110 being undrivable for a period of time.

Historical data and analysis database 133f may be configured to store historical data and other known data corresponding to information associated with vehicle 110, vehicle operational data of previous accidents, as well as analysis data corresponding to past performances of accident and drivability identification and transportation arrangement. As stated above, in some instances, such data may be utilized by machine learning engine 133e to calibrate machine learning algorithms used by accident identification engine 133b of transportation arrangement computing device 130 in performing the cross-platform transportation arrangement.

Visual element database 133g may be configured to store information corresponding to the textual and visual elements of one or more of transportation arrangement application 117 of on-board computer 115 of vehicle 110 and/or mobile device 120 and a webpage associated with transportation arrangement computing device 130. In particular, such textual and visual elements may include font styles, sizes, and colors, user interface formatting information such as indentations, spacing, content arrangement information and positioning, page color schemes, imagery information, and the like.

FIGS. 2A, 2B, 2C, 2D, 2E, and 2F depict an illustrative event sequence for facilitating cross-platform transportation arrangements in accordance with one or more aspects of the disclosure. While the steps shown in FIGS. 2A, 2B, 2C, 2D, 2E, and 2F are presented sequentially, the steps need not follow the sequence presented and may occur in any order. Moreover, the steps described below as being performed by mobile device 120 and transportation arrangement computing device 130 may be performed by any one, or combination of, on-board computing device 115, mobile device 120, and transportation arrangement computing device 130.

Referring to FIG. 2A, at step 201, vehicle 110 may transmit vehicle operational data to transportation arrangement computing device 130. In some instances, the vehicle operational data may be transmitted by one or more of vehicle operation sensors 111, GPS 112, telematics device 113, vehicle communication system 114, on-board computer 115, and the like as one or more electronic signals. Additionally and/or alternatively, the vehicle operational data may be transmitted by mobile device 120. The vehicle operational data may include all of the items of the vehicle operational data listed above, or a portion of the vehicle operational data (e.g., velocity, rates of acceleration and/or deceleration, braking, swerving, impact to the body of the vehicle, air bag deployment, and the like). In some instances, the vehicle operational data may be transmitted in real-time in a continuous data stream. Alternatively, the vehicle operational data may be transmitted in response to the occurrence of a particular vehicle event (e.g., airbag deployment).

At step 202, the accident identification engine 133b of transportation arrangement computing device 130 may receive the vehicle operational data (e.g., one or more electronic signals) from one or more of vehicle operation sensors 111, GPS 112, telematics device 113, vehicle communication system 114, on-board computer 115, mobile device 120, and the like through the communication interface(s) 132. At step 203, the accident identification engine 133b may process the received one or more electronic signals corresponding to the vehicle operational data. In particular, the accident identification engine 133b may perform one or more of smoothing, filtering, transforming (e.g., Fourier Transform, Discrete Fourier Transform, Fast Fourier Transform, and the like), companding, limiting, noise gating, and the like to isolate the vehicle operational data from the electronic signal sent from one or more of vehicle operation sensors 111, GPS 112, telematics device 113, vehicle communication system 114, on-board computer 115, mobile device 120, and the like comprising the vehicle operational data.

At step 204, the accident identification engine 133b of transportation arrangement computing device 130 may identify whether vehicle 110 was involved in an accident, based on the vehicle operational data received by way of the communication interface(s) 132. For example, accident identification engine 133b of transportation arrangement computing device 130 may receive vehicle operational data indicating that vehicle 110 has decelerated from 45 mph to 0 mph with high rotational velocity (e.g., swerving) and air bag deployment. Such data, when analyzed by the accident identification engine 133b of transportation arrangement computing device 130, may indicate that vehicle 110 has been involved in an accident. In some instances, the accident identification engine 133b of transportation arrangement computing device 130 may receive telematics data corresponding at least in part to impact data from pressure sensors on the body of the vehicle 110, which may indicate that vehicle 110 has been involved in an accident.

Referring to FIG. 2B, at step 205, the accident identification engine 133b may identify whether or not vehicle 110 is drivable after the accident. In particular, accident identification engine 133b may compare the vehicle operational data received at step 202 with vehicle operational data stored in historical data and analysis database 133f corresponding to previous accidents which caused the corresponding vehicles to be undrivable. Accident identification engine 133b may isolate vehicle operational data stored in historical data and analysis database 133f corresponding to previous accidents which caused the corresponding vehicles to be undrivable based on the make, model, and year associated with vehicle 110. Further, through usage of machine learning engine 133e, accident identification engine 133b may identify one or more sets of vehicle operational data stored in historical data and analysis database 133f which are correlated to the vehicle operational data of vehicle 110 at the time of the accident. Based on a degree of confidence of the correlations being above a predetermined threshold, accident identification engine 133b may determine that vehicle 110 is undrivable after the accident.

At step 206, the transportation arrangement engine 133c of the transportation arrangement computing device 130 may identify one or more transportation service providers proximate to the location of vehicle 110. In doing so, transportation arrangement engine 133c may query historical data and analysis database 133f and/or one or more of the third party computing device(s) 140 with locational information of the vehicle 110. As stated above, in some instances, transportation arrangement engine 133c may identify one or more transportation service providers beyond the location of vehicle 110.

At step 207, transportation arrangement engine 133c may scrape one or more webpages and/or applications associated with the third party computing device(s) 140. As stated above, the scraping may include fetching the content of one or more webpages and/or applications associated with the third party computing device(s) 140 and extracting page content such as type of transportation (e.g., ride share, public transportation, rental vehicle, and the like) and input fields to arrange transportation (e.g., location, destination, payment information, transportation option, and the like) through parsing, searching, and reformatting.

At step 208, transportation arrangement engine 133c may populate a transportation arrangement resource shell with information scraped from the one or more third party computing device(s) 140 at step 207. The transportation arrangement resource shell may serve as a framework and/or template for one or more of a webpage and an application interface and the scraped information may include transportation type and the input fields for arranging the corresponding transportation type. Further, the transportation arrangement resource shell may provide construct through which the scraped information may be arranged, but with or without stylistic elements.

Referring to FIG. 2C, at step 209, transportation arrangement engine 133c may retrieve visual element data from visual element database 133g of transportation arrangement computing device 130. Such data may include font styles, sizes, and colors, user interface formatting information such as indentations, spacing, content arrangement information and positioning, page color schemes, imagery information, and the like.

At step 210, transportation arrangement engine 133c may generate a composite rendering, based off of the transportation arrangement resource shell, that displays the information associated with the one or more third party computing device(s) 140 with visually perceptible elements of the retrieved data corresponding transportation arrangement application 117 of the on-board computer 115 of vehicle 110 and/or of mobile device 120 and/or a webpage associated with transportation arrangement computing device 130. The composite rendering may be a hybrid user interface that includes the data scraped from the one or more third party computing device(s) at step 207 and the visual elements retrieved from visual element database 133g at step 209. In particular, the scraped content from the one or more third party computing device(s) 140 may be generated with the visually perceptible elements of the retrieved data corresponding transportation arrangement application 117 of the on-board computer 115 of vehicle 110 and/or of mobile device 120 and/or a webpage associated with transportation arrangement computing device 130. As such, the transportation arrangement computing device 130 may be able to control the user experience by presenting developing information for presentation with homogeneous and standardized formatting.

At step 211, transportation arrangement engine 133c of transportation arrangement computing device 130 may provide a link for the composite rendering to the mobile device 120 associated with the owner of vehicle 110 involved in the accident through the communication interface(s) 132. In some instances, the provision of the link for the composite rendering may be sent through text message, email, push notification, and/or the like. The text message, email, push notification, and/or the like may include one or more of a uniform resource locator (URL) associated with the composite rendering, an activation link for transportation arrangement application 117, and/or a download link for transportation arrangement application 117.

Further, while the generation of the composite rendering and provisioning of the link to the composite rendering is described above as being performed in relation to an owner of vehicle 110 being involved in an accident, in some embodiments, such processes may be performed independently and/or in response to a user request provided by on-board computer 115, mobile device 120, and/or another computing device (e.g., tablet, laptop, desktop computer, and the like). For example, a user may engage in facilitating transportation arrangement by accessing a webpage associated with transportation arrangement computing device 130 and/or activating transportation arrangement application 117. The accessing may cause the transportation arrangement computing device 130, by way of an associated webpage or application 117, to generate the composite rendering in the manner described above. Additionally and/or alternatively, the transportation arrangement computing device 130, by way of an associated webpage or application 117, may request locational information associated with the user in order to generate the composite rendering.

At step 212, the owner of vehicle 110 may receive the link to the composite rendering at mobile device 120 through one or more of a text message, email, push notification, and the like. In some instances, the link to the composite rendering may be received at an alternate computing device such as on-board computer 115 and/or a tablet, laptop, and/or a desktop computer. As stated above, the text message, email, push notification, and/or the like may include one or more of a URL associated with the composite rendering, an activation link for transportation arrangement application 117, and/or a download link for transportation arrangement application 117.

Referring to FIG. 2D, at step 213, a user of mobile device 120 may activate the link to the composite rendering by launching one or more of the URL associated with the composite rendering, the activation link for transportation arrangement application 117, and/or the download link for transportation arrangement application 117. In some instances, the activation may be performed by launching one or more of the URL associated with the composite rendering, the activation link for transportation arrangement application 117, and/or the download link for transportation arrangement application 117 through one or more of on-board computer 115 and/or a tablet, laptop, and/or a desktop computer.

At step 214, transportation arrangement engine 133c of transportation arrangement computing device 130 may provide access to the composite rendering to mobile device 120. In some instances, the access to the composite rendering may be provided to one or more on-board computer 115 and/or a tablet, laptop, and/or a desktop computer. In providing access to the composite rendering, transportation arrangement engine 133c may perform one or more functions depending on which link for the composite rendering was activated by the user. For example, in the event that the user activated the URL associated with the composite rendering, transportation arrangement engine 133c may provide data to the computing device (e.g., mobile device 120) corresponding to the composite rendering. In the event that the user activated the link for the transportation arrangement application 117, transportation arrangement engine 133c may cause the computing device to launch the transportation arrangement application 117 with the composite rendering as the landing interface. In the event that the user activated the download link for the transportation arrangement application 117, transportation arrangement engine 133c may cause the computing device to download the transportation arrangement application 117 with the composite rendering as the landing interface.

At step 215, a user may provide account information associated with the transportation arrangement computing device 130. In providing account information for transportation arrangement computing device 130, a user may be able to provide transportation requests that are deducted from a credited payment account based a time period for repairing vehicle 110. Additionally and/or alternatively, through providing account information for transportation arrangement computing device 130, information corresponding to vehicle 110 such as make, model, year, and vehicle type (e.g., coupe, sedan, truck, mini-van, and the like) may be established by transportation arrangement engine 133c as presets when arranging for particular types of transportation. For example, if vehicle 110 is an extended cab truck, transportation arrangement engine 133c may preselect and/or order vehicles similar the user's extended cab truck when the user selects a rental vehicle transportation request. In some instances, the user may further provide account information for one or more of the third party computing device(s) 140 associated with transportation providers.

At step 216, transportation arrangement engine 133c may verify the account information for transportation arrangement computing device 130 by checking the information provided by the user at step 215 with user account information stored in user profile database 133a. In instances in which the user provides account information for one or more of the third party computing device(s) 140, transportation arrangement engine 133c may forward such information to the one or more proper third party computing device(s) 140.

Referring to FIG. 2E, at step 217, a user of mobile device 120 may create a transportation request through the composite rendering by causing an electronic signal to be sent to transportation arrangement computing device 130, which includes information for facilitating the transportation arrangement request. In some instances the creation of the transportation request may be performed through one or more of more on-board computer 115 and/or a tablet, laptop, and/or a desktop computer. In creating the transportation request, the user may select a type of transportation (e.g., ride share, public transportation, rental vehicle, and the like) and provide entries to the input fields for arranging the selected transportation type. For example, in the event that the user selects the ‘ride share’ transportation type, the user may further provide information for arranging the ride share request including pick up location, destination, vehicle level (e.g., economy vehicle, luxury vehicle, economy SUV, luxury SUV, and the like), number of seats needed (e.g., one, two, three, and the like), ride type (e.g., personal ride, shared ride), and the like. In the event that the user selects the ‘public transportation’ transportation type, the user may further provide information for arranging the public transportation request including public transportation type (e.g., bus, light rail, metro, streetcar, trolley subway, and the like), pick up location, destination and/or direction, and the like. In the event that the user selects the ‘rental vehicle’ transportation type, the user may further provide information for arranging the rental vehicle transportation request including rental car provider, vehicle level (e.g., intermediate, full size, intermediate SUV, compact, standard, specialty, luxury, convertible, and the like), pick-up location, drop-off location, pick-up date, drop-off date, and the like. In some instances, a vehicle of a similar make and model to that of the user may be established as default selections.

At step 218, the transportation arrangement engine 133c of the transportation arrangement computing device 130 may receive an electronic signal indicating the transportation request from the mobile device 120 of the user. In some instances, the transportation arrangement engine 133c of the transportation arrangement computing device 130 may receive the transportation request from one or more of the on-board computer 115 and/or a tablet, laptop, and/or a desktop computer. At step 219, the transportation arrangement engine 133c may provide the transportation request to the appropriate third party computing device from the one or more third party computing device(s) 140 corresponding to the transportation provider selected by the user. In providing the transportation request, the transportation arrangement engine 133c may include the information for arranging the requested transportation provided by the user at step 217. In some instances, the payment module 133d may coordinate the payment information with the appropriate third party computing device from the one or more third party computing device(s) 140 corresponding to the transportation provider selected by the user. As stated above, the payment provided by payment module 133d may be from a payment account credited with an amount of funds and/or linked to one or more payment accounts associated with the owner of vehicle 110. In some instances, the funds may be associated with an insurance claim. By doing so, the transportation arrangement computing device 130 may be able to maintain traffic on the webpage associated with transportation arrangement computing device 130 and/or transportation arrangement application 117 corresponding to transportation arrangement computing device 130. Further, the transportation arrangement computing device 130 may command data produced by the user in interactions with the third party platforms. At step 220, the appropriate third party computing device from the one or more third party computing device(s) 140 may receive the transportation request from transportation arrangement computing device 130. At step 221, the third party computing device 140 may process the transportation request.

Referring to FIG. 2F, at step 222, the third party computing device 140 may provide a confirmation to transportation arrangement computing device 130 by way of transportation arrangement engine 133c. At step 223, transportation arrangement engine 133c may receive the confirmation from the third party computing device 140. At step 224, in instances in which the account of the user is credited based on the vehicle 110 being undrivable for a period of time, payment module 133d of transportation arrangement computing device 130 may deduct the cost of the transportation from the payment account. At step 225, the transportation arrangement engine 133c may relay the transportation arrangement confirmation to mobile device 120. In some instances, the transportation arrangement engine 133c may relay the transportation arrangement confirmation to one or more of on-board computer 115 and/or a tablet, laptop, and/or a desktop computer associated with the user. The transportation arrangement confirmation may further include one or more of policy coverage information such as daily limit, total limits, and available cash out options, option to provide additional payment information to cover costs in excess of the policy coverage, when the user can obtain an alternate transportation arrangement, and the like. At step 226, the transportation arrangement engine 133c may provide updates to the user regarding progress, timeframe, and completion of the repairs to the vehicle 110 of the user, notifications regarding automatic extensions of a rental vehicle if repairs to the user's vehicle are not complete, reminders to drop of the rental vehicle when repairs are complete, notifications that the user may be responsible for transportation service costs if the rental car is not returned when due, and the like.

FIG. 3 illustrates one example method for facilitating cross-platform transportation arrangements in accordance with one or more example embodiments. Referring to FIG. 3, at step 305, a first computing device may scrape information from one or more third party computing devices. At step 310, the first computing device may populate a transportation arrangement resource shell with the information scraped from the one or more third party computing devices. At step 315, in response to populating the transportation arrangement resource shell, the first computing device may retrieve stored data corresponding to the first computing device. At step 320, using the retrieved data, the first computing device may generate a composite rendering that displays information associated with the one or more third party computing devices with visually perceptible elements of the retrieved data corresponding to the first computing device.

As noted above, the present disclosure enables the facilitation of cross-platform transportation arrangements while providing technological improvements as compared to existing systems. In particular, through scraping information from one or more third party computing devices, populating a transportation arrangement resource shell with the scraped information, and generating a composite rendering with the scraped information and visual elements of a host platform, the disclosure serves to provide a homogenous user experience for a user in facilitating transportation arrangements. Furthermore, by enabling a user to interact with third party transportation providers through the composite rendering, the disclosure enables the preservation of user traffic, as well as command over user data generated during the facilitation of transportation arrangement. Such aspects of the disclosure address major technological deficiencies in existing systems and, accordingly, provide meaningful technological improvements.

FIG. 4 illustrates a block diagram of a transportation arrangement computing device 401 in a system that may be used according to one or more illustrative embodiments of the disclosure. The transportation arrangement computing device 401 may have a processor 403 for controlling overall operation of a transportation arrangement computing device 401 and its associated components, including RAM 405, ROM 407, input/output module 409, and memory unit 415. The transportation arrangement computing device 401, along with one or more additional devices (e.g., terminals 441, 451) may correspond to any of multiple systems or devices, such as transportation arrangement systems, configured as described herein for performing methods for facilitating cross-platform transportation arrangements.

Input/Output (I/O) module 409 may include a microphone, keypad, touch screen, and/or stylus through which a user of the transportation arrangement computing device 401 may provide input, and may also include one or more of a speaker for providing audio input/output and a video display device for providing textual, audiovisual and/or graphical output. Software may be stored within memory unit 415 and/or other storage to provide instructions to processor 403 for enabling transportation arrangement computing device 401 to perform various functions. For example, memory unit 415 may store software used by the transportation arrangement computing device 401, such as an operating system 417, application programs 419, and an associated internal database 421. The memory unit 415 includes one or more of volatile and/or non-volatile computer memory to store computer-executable instructions, data, and/or other information. Processor 403 and its associated components may allow the transportation arrangement computing device 401 to execute a series of computer-readable instructions to perform the one or more of the processes or functions described herein.

The transportation arrangement computing device 401 may operate in a networked environment 400 supporting connections to one or more remote computers, such as terminals/devices 441 and 451. Transportation arrangement computing device 401, and related terminals/devices 441 and 451, may include devices installed in vehicles and/or mobile devices that may travel within vehicles, or devices outside of vehicles that are configured to perform aspects of the processes described herein. Thus, transportation arrangement computing device 401 and terminals/devices 441 and 451 may each include personal computers (e.g., laptop, desktop, or tablet computers), servers (e.g., web servers, database servers), vehicle-based devices (e.g., on-board vehicle computers, short-range vehicle communication systems, sensors, and telematics devices), or mobile communication devices (e.g., mobile phones, portable computing devices, and the like), and may include some or all of the elements described above with respect to the transportation arrangement computing device 401. The network connections depicted in FIG. 4 include a local area network (LAN) 425 and a wide area network (WAN) 429, and a wireless telecommunications network 433, but may also include other networks. When used in a LAN networking environment, the transportation arrangement computing device 401 may be connected to the LAN 425 through a network interface or adapter 423. When used in a WAN networking environment, the transportation arrangement computing device 401 may include a modem 427 or other means for establishing communications over the WAN 429, such as network 431 (e.g., the Internet). When used in a wireless telecommunications network 433, the transportation arrangement computing device 401 may include one or more transceivers, digital signal processors, and additional circuitry and software for communicating with wireless computing devices 441 (e.g., mobile phones, short-range vehicle communication systems, vehicle sensing and telematics devices) via one or more network devices 435 (e.g., base transceiver stations) in the wireless network 433.

It will be appreciated that the network connections shown are illustrative and other means of establishing a communications link between the computers may be used. The existence of any of various network protocols such as TCP/IP, Ethernet, FTP, HTTP and the like, and of various wireless communication technologies such as GSM, CDMA, Wi-Fi, and WiMAX, is presumed, and the various computing devices and components described herein may be configured to communicate using any of these network protocols or technologies.

Additionally, one or more application programs 419 used by the computing device 401 may include computer executable instructions for receiving data and performing other related functions as described herein.

As will be appreciated by one of skill in the art, the various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A method comprising:
scraping, by a first computing device, information from one or more third party computing devices;
populating, by the first computing device, a transportation arrangement resource shell with the information from the one or more third party computing devices;
in response to populating the transportation arrangement resource shell, retrieving, by the first computing device, stored data corresponding to the first computing device; and
using the retrieved data, generating a composite rendering by the first computing device that provides information associated with the one or more third party computing devices with visually perceptible elements of the retrieved data corresponding to the first computing device.

2. The method of claim 1, further comprising:
receiving, at the first computing device, a signal indicating a transportation arrangement request through the composite rendering from a user computing device; and
facilitating, by the first computing device, the transportation arrangement request between a third party computing device from the one or more third party computing devices corresponding to the transportation arrangement request and the user computing device.

3. The method of claim 2, further comprising:
identifying, at the first computing device, a credit amount associated with a policy of a user of the first computing device; and
deducting, at the first computing device, an amount corresponding to a value of the transportation arrangement request from the credit amount associated with the policy of the user.

4. The method of claim 1, wherein the scraping information from one or more third party computing devices includes:
fetching, by the first computing device, content from one or more third party computing devices; and
extracting, by the first computing device, page content from the fetched content, the page content including at least a type of transportation and one or more input fields for arranging the type of transportation.

5. The method of claim 1, wherein the composite rendering provides the information from the one or more third party computing devices in a construct provided by the transportation arrangement resource shell with visual elements corresponding to the first computing device.

6. The method of claim 1, wherein the one or more third party computing devices are associated with one or more of ride share services, rental car services, and public transportation services.

7. The method of claim 6, further comprising:
identifying, by the first computing devices, one or more of the ride share services, rental car services, and public transportation services corresponding to the one or more third party computing devices based on locational data received from a user computing device.

8. An apparatus comprising:
a processor; and
a memory storing computer executable instructions that, when executed by the processor, cause the apparatus to:
scrape information from one or more third party computing devices;
populate a transportation arrangement resource shell with the information from the one or more third party computing devices;
in response to populating the transportation arrangement resource shell, retrieve stored data corresponding to the apparatus; and
using the retrieved data, generate a composite rendering that provides information associated with the one or more third party computing devices with visually perceptible elements of the retrieved data corresponding to the apparatus.

9. The apparatus of claim 8, wherein the memory stores further computer executable instructions that, when executed by the processor, cause the apparatus to:
receive a signal indicating a transportation arrangement request through the composite rendering from a user computing device; and
facilitate the transportation arrangement request between a third party computing device from the one or more third party computing devices corresponding to the transportation resource request and the user computing device.

10. The apparatus of claim 9, wherein the memory stores further computer executable instructions that, when executed by the processor, cause the apparatus to:
identify a credit amount associated with a policy of a user of the apparatus; and
deduct an amount corresponding to a value of the transportation arrangement request from the credit amount associated with the policy of the user.

11. The apparatus of claim 8, wherein the memory stores further computer executable instructions that, when executed by the processor, cause the apparatus to:
fetch content from one or more third party computing devices; and
extract page content from the fetched content, the page content including at least a type of transportation and one or more input fields for arranging the type of transportation.

12. The apparatus of claim 8, wherein the composite rendering provides the information from the one or more third party computing devices in a construct provided by the transportation arrangement resource shell with visual elements corresponding to the apparatus.

13. The apparatus of claim 8, wherein the one or more third party computing devices are associated with one or more of ride share services, rental car services, and public transportation services.

14. The apparatus of claim 13, wherein the memory stores further computer executable instructions that, when executed by the processor, cause the apparatus to:
identify one or more of the ride share services, rental car services, and public transportation services corresponding to the one or more third party computing devices based on locational data received from a user computing device.

15. A non-transitory computer-readable storage medium having computer executable program instructions stored thereon that, when executed by at least one processor, cause a transportation arrangement computing device to:
scrape information from one or more third party computing devices;
populate a transportation arrangement resource shell with the information from the one or more third party computing devices;
in response to populating the transportation arrangement resource shell, retrieve stored data corresponding to the transportation arrangement computing device; and
using the retrieved data, generate a composite rendering that provides information associated with the one or more third party computing devices with visually perceptible elements of the retrieved data corresponding to the transportation arrangement computing device.

16. The non-transitory computer-readable storage medium of claim 15, wherein the computer executable program instructions, when executed by the processor, further cause the transportation arrangement computing device to:
receive a signal indicating a transportation arrangement request through the composite rendering from a user computing device; and
facilitate the transportation arrangement request between a third party computing device from the one or more third party computing devices corresponding to the transportation resource request and the user computing device.

17. The non-transitory computer-readable storage medium of claim 16, wherein the computer executable program instructions, when executed by the processor, further cause the transportation arrangement computing device to:
identify a credit amount associated with a policy of a user of the transportation arrangement computing device; and
deduct an amount corresponding to a value of the transportation arrangement request from the credit amount associated with the policy of the user.

18. The non-transitory computer-readable storage medium of claim 15, wherein the computer executable program instructions, when executed by the processor, further cause the transportation arrangement computing device to:
fetch content from the one or more third party computing devices; and
extract page content from the fetched content, the page content including at least a type of transportation and one or more input fields for arranging the type of transportation.

19. The non-transitory computer-readable storage medium of claim 15, wherein the composite rendering provides the information from the one or more third party computing devices in a construct provided by the transportation arrangement resource shell with visual elements corresponding to the transportation arrangement computing device.

20. The non-transitory computer-readable storage medium of claim 15, wherein the one or more third party computing devices are associated with one or more of ride share services, rental car services, and public transportation services, and wherein the computer executable program instructions, when executed by the processor, further cause the transportation arrangement computing device to:
identify one or more of the ride share services, rental car services, and public transportation services corresponding to the one or more third party computing devices based on locational data received from a user computing device.
